(19) United States
(12) Patent Application Publication
(10) Pub. No.: US 2006/0215738 A1
(43) Pub. Date: Sep. 28, 2006

(54) Data detection in communication system

(75) Inventor: Mikko Kokkonen, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: NOKIA CORPORATION

(21) Appl. No.: 11/376,100

(22) Filed: Mar. 16, 2006

(30) Foreign Application Priority Data
Mar. 22, 2005 (FI) 20055127

(51) Int. Cl. H04B 1/00

(52) U.S. Cl. 375/148

(57) ABSTRACT

A method for detecting symbols is provided in a communication system. Symbols are received simultaneously through multiple spreading code channels. The received symbols are detected by processing one received symbol at a time, calculating reliability metrics recursively from a symbol received through a first spreading code channel for each possibly transmitted symbol by comparing each possibly transmitted symbol with each rake receiver finger adapted to the received symbol at a time, and selecting, based on the reliability metrics, a number of most probable candidate symbols for further processing. The process then calculates reliability metrics from a symbol received through a second spreading code channel using the reliability metrics for the most probable candidates. The method utilizes effectively cross-correlation properties of the spreading codes associated with the spreading code channels.

### FIELD

The invention relates to symbol sequence detection in a radio receiver, which utilizes a rake reception mechanism.

### BACKGROUND

A CDMA (Code Division Multiple Access) transmitter transmits a data symbol by modulating a spreading code sequence with the data symbol. Several symbols are usually transmitted at the same time on the same frequency band by associating a unique spreading code to each data symbol. A receiver may have to detect data symbols in multiple spreading code channels. The receiver can discriminate the signals using correlation properties of the spreading codes.

A transmitted data signal is corrupted in a radio channel by multipath propagation of the signal and thermal noise, and thus data detection is necessary in a receiver. A data detection algorithm estimates transmitted symbols from the received signal samples. If no substantial correlation exists between spreading codes received by the receiver, use of a “rake reception” mechanism in the receiver will suffice.

Higher correlation between the spreading codes may be due to signal corruption in the radio channel caused by multipath propagation and noise. An effect of multipath propagation may be reduced by implementing a chip-level equalizer in the receiver. Chip-level equalizers work reasonably well with single antenna transmission, but cannot completely restore orthogonality of the spreading codes in some schemes with space-time block codes [e.g. space-time block coding transmit diversity (STTD) transmission with one receive antenna].

Parallel interference cancellation is a widely studied detection alternative. It is an iterative algorithm that uses rake receiver estimates as a starting point. Error performance of the parallel interference cancellation receivers is suboptimal when many codes are used simultaneously, because the estimates from the rake receiver are corrupted with interference from other codes.

Algorithms called “breadth-first” search algorithms are also known from prior art as detection algorithms for detection of multiple symbols received simultaneously with each symbol modulated with a different spreading code. One breadth-first detection algorithm (an algorithm with a matched filter metric) is an algorithm which takes cross-correlation properties of the received spreading codes into account only partially, and is therefore suboptimal. Additionally, it cannot be implemented with space-time block coding. Another breadth-first detection algorithm uses linear filtering before the breadth-first search in order to partially decorrelate the spreading codes, while keeping the noise white. It provides a decent performance, but its implementation is, however, computationally very complex in systems that use scrambling codes, since coefficients of the linear filters are computed from the spreading codes and the spreading codes change from symbol to symbol because of long scrambling codes.

### BRIEF DESCRIPTION OF THE INVENTION

An object of the invention is to provide an improved solution for symbol detection in a radio receiver utilizing a rake receiver.

According to an aspect of the invention, there is provided a symbol detection method in a radio receiver utilizing a rake receiver. The method comprises receiving a signal comprising a plurality of symbols, each symbol being modulated with a different spreading code, adapting rake receiver fingers to properties of radio channels related to a symbol of each spreading code, and despreading the received signal with each spreading code sequence in order to form despread symbols. The method further comprises calculating, from a despread symbol of a first spreading code a reliability metric for each possibly transmitted symbol by comparing each possibly transmitted symbol with each rake receiver finger related to the received symbol at a time, selecting, based on the reliability metrics, a number of most probable candidates for the transmitted symbol for further processing, calculating recursively reliability metrics from a despread symbol of each spreading code by taking into account reliability metrics calculated for the most probable candidates preceding the symbol currently being processed and by comparing each possibly transmitted symbol with each rake receiver finger related to the received symbol at a time, the reliability metric comprising more information on cross-correlation properties between the spreading codes after every calculation of the reliability metric, and selecting, after calculating the reliability metrics for each possibly transmitted symbol, a number of most probable candidates for the transmitted symbol sequences based on the reliability metrics.

According to another aspect of the invention, there is provided a radio receiver utilizing a rake receiver. The radio receiver comprises a communication interface for receiving a signal comprising a plurality of symbols, each symbol being modulated with a different spreading code sequence and a control unit configured to adapt rake receiver fingers to properties of a radio channel related to a symbol of each spreading code, and despread the received signal with each spreading code sequence in order to form despread symbols. The control unit is further configured to calculate, from a despread symbol of a first spreading code, a reliability metric for each possibly transmitted symbol by comparing each possibly transmitted symbol with each rake receiver finger related to the received symbol at a time, select, based on the reliability metrics, a number of most probable candidates for the transmitted symbol for further processing, calculate recursively reliability metrics from a despread symbol of each spreading code by taking into account reliability metrics calculated for the most probable candidates preceding the symbol currently being processed and by comparing each possibly transmitted symbol with each rake receiver finger related to the received symbol at a time, the reliability metric comprising more information on cross-correlation properties between the spreading codes after every calculation of the reliability metric, and select, after calculating the reliability metrics for each possibly transmitted symbol, a number of most probable candidates for the transmitted symbol sequences based on the reliability metrics.

According to another aspect of the invention, there is provided a computer program product encoding a computer program of instructions for executing a computer process of symbol detection in a radio receiver utilizing a rake receiver. The process comprises receiving a signal comprising a plurality of symbols, each symbol being modulated with a different spreading code sequence, adapting rake receiver fingers to properties of a radio channel related to a symbol of each spreading code, and despreading the received signal with each spreading code sequence in order to form despread symbols. The process further comprises calculating, from a despread symbol of a first spreading code, a reliability metric for each possibly transmitted symbol by comparing each possibly transmitted symbol with each rake receiver finger related to the received symbol at a time, selecting, based on the reliability metrics, a number of most probable candidates for the transmitted symbol for further processing, calculating recursively reliability metrics from a despread symbol of each spreading code by taking into account reliability metrics calculated for the most probable candidates preceding the symbol currently being processed and by comparing each possibly transmitted symbol with each rake receiver finger related to the received symbol at a time, the reliability metric comprising more information on cross-correlation properties between the spreading codes after every calculation of the reliability metric, and selecting, after calculating the reliability metrics for each possibly transmitted symbol, a number of most probable candidates for the transmitted symbol sequences based on the reliability metrics.

According to another aspect of the invention, there is provided a computer program distribution medium readable by a computer and encoding a computer program of instructions for executing computer process of symbol detection in a radio receiver utilizing a rake receiver. The process comprises receiving a signal comprising a plurality of symbols, each symbol being modulated with a different spreading code sequence, adapting rake receiver fingers to properties of a radio channel related to a symbol of each spreading code, and despreading the received signal with each spreading code sequence in order to form despread symbols. The process further comprises calculating, from a despread symbol of a first spreading code, a reliability metric for each possibly transmitted symbol by comparing each possibly transmitted symbol with each rake receiver finger related to the received symbol at a time, selecting, based on the reliability metrics, a number of most probable candidates for the transmitted symbol for further processing, calculating recursively reliability metrics from a despread symbol of each spreading code by taking into account reliability metrics calculated for the most probable candidates preceding the symbol currently being processed and by comparing each possibly transmitted symbol with each rake receiver finger related to the received symbol at a time, the reliability metric comprising more information on cross-correlation properties between the spreading codes after every calculation of the reliability metric, and selecting, after calculating the reliability metrics for each possibly transmitted symbol, a number of most probable candidates for the transmitted symbol sequences based on the reliability metrics.

The invention provides several advantages. The present invention provides a flexible solution for data detection that may also be used with space-time block coded transmission of data. It provides a very good error performance with reasonable computational complexity, and it also benefits from various diversity sources (such as multipath diversity or spatial diversity through transmit diversity methods). Additionally, the invention effectively utilizes the cross-correlation properties of the spreading codes used in the transmission. The provided solution is also flexible in the sense that error performance can be traded off with computational complexity, if desired.

### LIST OF DRAWINGS

In the following, the invention will be described in greater detail with reference to the embodiments and the accompanying drawings, in which

FIG. 1 illustrates a communication system in which embodiments of the invention may be implemented;

FIG. 2 illustrates a radio receiver according to an embodiment of the invention;

FIG. 3 illustrates a tree-type detection procedure according to an embodiment of the invention, and

FIG. 4 is a flow diagram illustrating a method of detecting a data sequence in a radio receiver utilizing a rake reception mechanism according to an embodiment of the invention.

### DESCRIPTION OF EMBODIMENTS

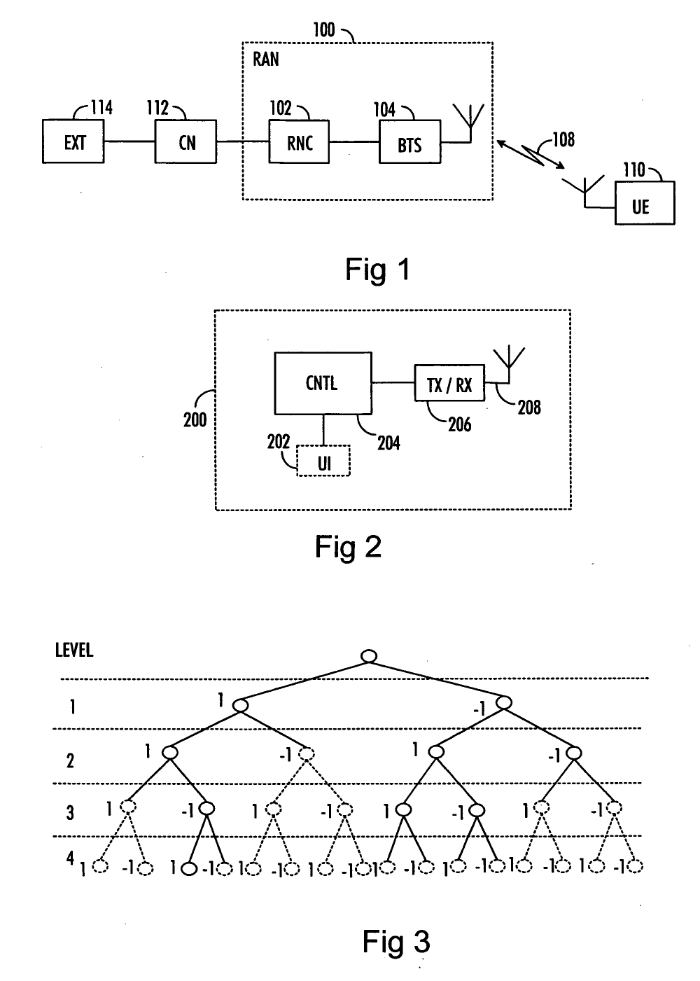

With reference to FIG. 1, examine an example of a communication system to which embodiments of the invention may be applied. The structure and elements of the system illustrated in FIG. 1 are the same as in a Universal Mobile Telecommunication System (UMTS) network, but it should, however, be noted that the implementation of the proposed data detection method is not limited to a UMTS system, but it may also be implemented in other suitable communication systems, such as a Wireless Local Area Network (WLAN).

The network elements of the communication system of FIG. 1 can be grouped into a radio access network (RAN) 100 which handles all radio-related functionalities of the system, and a core network (CN) 112 which takes care of switching and routing calls and data connections to external networks 114. An external network may, for example, be the Internet, an Integrated Services Digital Network (ISDN), or a Public Switched Telephone Network (PSTN).

The radio access network 100 comprises one or more base transceiver stations (BTS) 104 and a radio network controllers (RNC) 102, 106. A BTS 104 is responsible for providing the user equipment 110 with an air interface radio connection 108 within its coverage area also known as a cell. The BTS 104 also performs physical level signal processing like modulation, channel coding, etc. The BTS 104 may also perform some basic radio resource management operations like operations related to power control.

A radio network controller 102 is a network element which is responsible for controlling radio resources in the RAN 100. The RNC 102 serves as a switching and controlling element of the RAN 100, and typically controls several BTSs 104, but it may also control only a single BTS 104. The RNC 102 is responsible for controlling load and congestion of traffic channels of its own cells. The RNC 102 also takes care of procedures related to admission control, handovers, and power control. The radio network controller 102 typically includes a digital signal processor and software for executing computer processes stored on a computer readable medium. Furthermore, the radio network controller 102 typically includes connecting means for communicating electric signals with other network elements, such as other radio network controllers 106 and/or base transceiver stations 104, but also with the core network 112.

The core network 112 provides a combination of switching and transmission equipment, together forming a basis for telecommunication network services. The core network also performs procedures related to radio resource management. The core network 112 may provide user entities with circuit-switched and/or packet-switched data transport services.

Next, a structure of a radio receiver will be described with reference to FIG. 2. The radio receiver 200 may be a subscriber unit of a communication system, such as a mobile communication device, a personal digital assistant (PDA) or a computer with a communication interface to provide a radio connection. The radio receiver may also be a network element of a communication system, such as a base transceiver station or an access point to a communication network.

The radio receiver 200 comprises a communication interface 206 to receive, in conjunction with an antenna 208, information signals transmitted over a radio connection. If the radio receiver is a subscriber unit, the communication interface 206 may provide a connection with a communication network through a serving base transceiver station or an access point. The communication interface 206 may also provide a capability to transmit information signals over a radio interface.

The radio receiver 200 further comprises a control unit 204 to control functions of the radio receiver 200. The control unit 204 handles establishment, operation and termination of radio connections in the subscriber unit 200. Additionally the control unit 204 controls reception of information by controlling the processing of reception signals. The control unit 204 may be implemented by a digital signal processor with suitable software embedded on a computer readable medium, or by separate logic circuits, for example with ASIC (Application Specific Integrated Circuit).

The radio receiver 200 may further comprise a user interface 202 connected to the control unit 204. The user interface 202 may comprise a keyboard or a keypad and a display. Particularly if the radio receiver 200 is a subscriber unit, the user interface 202 may also comprise a microphone, a loudspeaker, and/or a camera.

The communication system and the radio receiver 200 described above may employ a direct sequence CDMA (DS-CDMA) technology, in which a constellation symbol is modulated with a higher data rate spreading code sequence. A CDMA transmitter transmits a symbol by modulating a spreading code sequence with the symbol. Several symbols may be transmitted from a transmitter at the same time on the same frequency band by associating a different spreading code to each symbol. For example, according to the 3GPP (3^{rd} Generation Partnership Project) UMTS specification, multiple spreading codes may be allocated to a subscriber unit for High Speed Downlink Packet Access (HSDPA) transmission. A base station also performs data detection for data symbols with each data symbol modulated with a different spreading code. A base station may carry out a multiuser detection scheme. The receiver can separate the signals using the correlation properties of the spreading codes. A transmitted baseband DS signal can be described by the following equation:

$${s}_{{iL}_{c} + k} = {\sum }_{j = 1}^{{N}_{c}} {x}_{i , j} {c}_{j , k} , \qquad ( 1 )$$

where x_{i,j} is the symbol associated with code j and transmitted during code period i, c_{j,k} is the k^{th} chip of the j^{th} spreading sequence, L_{c} is the length of the spreading sequence and N_{c} is the number of symbols transmitted at the same time, i.e. the number of spreading codes used in the transmission.

The transmitted signal propagates through a radio channel and is corrupted with additive white Gaussian noise (AWGN) and fading caused by multipath propagation such that the received signal can be characterized by the following equation:

$${r}_{k} = {\sum }_{p = 1}^{{N}_{p}} {α}_{p} {s}_{k - {d}_{p}} + {n}_{k} \qquad ( 2 )$$

where αₚ is a channel coefficient of the p^{th} path, dₚ is the delay of the p^{th} path, Nₚ is the number of resolvable paths and nₖ is a complex Gaussian noise sample.

The task of the detection algorithm in a CDMA radio receiver is to estimate transmitted symbols x_{i,j} given the received signal samples rₖ. If the correlation properties of the spreading codes were ideal (or at least sufficiently strong) a “rake receiver” would be sufficient. The rake receiver is adapted to the properties of the radio channel, thus being capable of receiving a multipath propagated information signal. The rake receiver may be adapted to properties of the radio channel using a known pilot sequence.

In a rake receiver the received signal rₖ is correlated with a spreading code to obtain “rake finger” outputs:

$${y}_{{jN}_{p} + p} = {\sum }_{n = 1}^{{L}_{c}} {c}_{j , n}^{*} {r}_{{iL}_{c} + {d}_{p}} \qquad ( 3 )$$

Rake finger outputs corresponding to received signal components and related to a particular spreading code may be stacked consecutively in a vector expressed as y. The length of the vector y depends on the number of rake fingers and the number of spreading codes. In the following, the term ‘spreading code channel’ will be used when referring to symbols transmitted using a determined spreading code.

Next, according to prior art, the rake finger outputs corresponding to a particular spreading code are combined in order to aggregate multipath propagated signal components. The combination may, for example, be based on a maximal ratio combining technique. As a result, a symbol sequence comprising received symbols is obtained. Above, a received signal of only one spreading code period has been considered. Such an interval is necessary for describing a detection solution without obscuring the solution unnecessarily. After combining the rake finger outputs, the received symbols may be demodulated using, for example, a matched filter demodulator. This procedure, however, results in crosstalk between different demodulator outputs if multiple spreading codes are processed in a radio receiver.

Crosstalk between the different spreading codes before combining the rake finger outputs may be quantified with the following cross-correlation matrix:

$$\begin{matrix}H = {\sum }_{i = 1}^{{N}_{P}} {α}_{i} [ \begin{matrix}X ( {d}_{i} - {d}_{1} ) \\ X ( {d}_{i} - {d}_{2} ) \\ X ( {d}_{i} - {d}_{3} ) \\ ⋮ \\ X ( {d}_{i} - {d}_{p} )\end{matrix} ] \\ where & ( 4 ) \\ X ( Δ ) = [ \begin{matrix}{x}_{11} ( Δ ) & {x}_{12} ( Δ ) & ⋯ & {x}_{1 {N}_{c}} ( Δ ) \\ {x}_{21} ( Δ ) & {x}_{22} ( Δ ) & ⋯ & {x}_{2 {N}_{c}} ( Δ ) \\ ⋮ & ⋮ & ⋰ & ⋮ \\ {x}_{{N}_{c} 1} ( Δ ) & {x}_{{N}_{c} 2} ( Δ ) & ⋯ & {x}_{{N}_{c} {N}_{c}} ( Δ )\end{matrix} ] & ( 5 )\end{matrix}$$

where xᵢⱼ(Δ) corresponds to cross-correlation between spreading codes i and j, and may be expressed as:

$${x}_{ij} ( Δ ) = \{ \begin{matrix}{\sum }_{k = 1}^{{L}_{c} - Δ} {c}_{i , k} {c}_{j , k + Δ}^{*} , & if Δ \geq 0 \\ {\sum }_{k = 1}^{{L}_{c}} {c}_{i , k} {c}_{j , k + Δ}^{*} , & if Δ < 0\end{matrix} \qquad ( 6 )$$

Thus, the cross-correlation matrix H of equation (4) actually comprises cross-correlations of each spreading code pair with each time delay dᵢ and attenuation αᵢ of each resolvable multipath propagation path. Thus, the size of the matrix depends on the number of spreading codes N_{c} and the number of resolvable paths represented by the number of rake fingers.

Next, an embodiment of a symbol detection technique according to an embodiment of the invention will be described with reference to FIG. 3 illustrating a tree-type representation of all possible transmitted symbol combinations. The symbol detection technique according to this embodiment may be carried out in a subscriber unit which communicates with a transmitter using a plurality of spreading codes for transmission of data. Thus, the subscriber unit receives simultaneously a plurality of symbols to be detected. The symbol detection technique according to this embodiment may also be carried out in a base station which receives simultaneously symbols from a plurality of subscriber units with each symbol modulated with a different spreading code. The base station may carry out detection of these symbols jointly. The symbol detection may be performed on a received signal, which has been analog-to-digital converted (A/D converted), and the symbol detection may be performed after synchronisation and channel estimation procedures have been carried out.

An object of sequence detection according to this embodiment of the invention is to calculate a “reliability metric” from a received symbol for each possibly transmitted symbol at each level described in FIG. 3, and to select a determined number of best candidates for further processing. The reliability metric describes a likelihood of the possibly transmitted symbol associated with the reliability metric actually being the transmitted symbol. The candidate selection is based on reliability metrics calculated for each possibly transmitted symbol. The number of possibly transmitted symbols depends on the symbol constellation employed in the communication. The symbol constellation is known in the radio receiver. After the selection of the candidates, the process moves to a next level. The method may also be called as a reduced breadth first search method.

In FIG. 3, a continuous line indicates that the following possibly transmitted symbol was evaluated by calculating the reliability metric during the detection process, and a dashed line indicates that the following possibly transmitted symbol was not evaluated, i.e. the reliability metric was not calculated. A circle drawn with a continuous line represents a symbol which, based on the reliability metric, was selected as one of the best candidates for the transmitted symbol, and a circle drawn with a dashed line represents a symbol which, as being an unlikely transmitted symbol, was discarded from further processing.

The number of levels in FIG. 3 corresponds to the number of spreading code channels associated with the radio receiver. In FIG. 3, four levels are shown, which means that four spreading code channels are associated with the radio receiver performing the symbol detection. The four spreading code channels may relate to communication of the receiver with one to four transmitters.

Further, according to the sequence detection process of FIG. 3, three best candidates for a transmitted symbol sequence have been selected at each level. Naturally, an exception is level 1, where only 2 possible symbols exist. The symbol constellation employed in this example comprises two possibilities for a transmitted symbol: 1 and −1. Naturally, the scope of the invention is not limited to these values of the number of spreading codes, the number of selected candidates, nor to the symbol constellation employed in this example.

At the first level, based on a received symbol related to a first spreading code channel, a reliability metric is calculated for both possibly transmitted symbols 1 and −1. The calculation of reliability metric M at level L+1 is based on the following equation:

$${M}_{L + 1} = {\sum }_{k = 1}^{{Λ}_{L} + {δ}_{L}} {\vert {y}_{k} - {\sum }_{l = 1}^{L + 1} {h}_{kl} {x}_{l} \vert}^{2} \qquad ( 7 )$$

where δ_{L} is a constant equal to the number of rake fingers, Λ_{L} is a summation of number of rake fingers over the previously processed levels L, i.e. Λ_{L}=Σₗ₌₁^{L}δₗ, where l is an index describing the previously processed levels, |•| denotes magnitude, yₖ is the k^{th} element of vector y comprising the rake finger outputs, hₖₗ is the k^{th} row and l^{th} column element of the cross-correlation matrix H, and xₗ is a symbol constellation symbol describing a possibly transmitted symbol.

The squared magnitude of equation (7) may be expanded, and, as a result, we obtain the following equation for reliability metric M_{L+1}:

$${M}_{L + 1} = \underbrace{{\sum }_{k = 1}^{{Λ}_{L}} {\vert {y}_{k} - {\sum }_{l = 1}^{L} {h}_{k , l} {x}_{l} \vert}^{2}}_{= {M}_{L}} + {\sum }_{k = {Λ}_{L} + 1}^{{Λ}_{L} + {δ}_{L}} {\vert {y}_{k} - {\sum }_{l = 1}^{L} {h}_{k , l} {x}_{l} \vert}^{2} + {\sum }_{k = 1}^{{Λ}_{L} + {δ}_{L}} {\vert {h}_{k , L + 1} {x}_{L + 1} \vert}^{2} - 2 ℛ [ {\sum }_{k = 1}^{{Λ}_{L} + {δ}_{L}} {( {y}_{k} - {\sum }_{l = 1}^{L} {h}_{k , l} {x}_{l} )}^{*} {h}_{k , L + 1} {x}_{L + 1} ] \qquad ( 8 )$$

where [symbol] denotes taking a real part of the signal and * denotes complex conjugate operation. As can be seen, reliability metric calculation is a recursive process, and reliability metric values calculated for the previous symbol(s) may be used when calculating reliability metrics for next received symbol(s). When calculating reliability metrics for a first received symbol, M_{L} of equation (8) may be initialised as 0, for example. Since the calculation of the reliability metric according to equation (8) is a recursive process and in each calculation of equation (8) more elements of the cross-correlation matrix H are taken into account, the reliability metric comprises more information on the cross-correlation properties between the spreading codes when the process moves to the next level, which is related to the next spreading code channel, and when new reliability metrics are calculated. The reliability metrics related to the first processed symbol (the first spreading code channel) contain little cross-correlation information, the reliability metrics related to the second processed symbol (the second spreading code channel) contain more information on the cross-correlation properties, and so on. The reliability metrics related to the last processed symbol (the last spreading code channel) contain a maximum amount of available information on the cross-correlation properties of the spreading codes.

The calculation of a reliability metric for a received symbol actually comprises calculating a difference, or Euclidean distance, between a received symbol and a possibly transmitted symbol. As mentioned above, the reliability metric is calculated for each possibly transmitted symbol. The reliability metric producing the lowest result, i.e. the lowest difference between the received symbol and the transmitted symbol corresponding to the reliability metric is considered to be the most probable transmitted symbol. In our example, two reliability metric values are calculated at level 1, and both values are stored for further processing.

Then, the process moves to level 2, where reliability metrics are calculated for possibly transmitted symbols {1, 1}, {1, −1}, {−1, 1} and {−1, −1}. The calculation may be carried out using equation (8), where M_{L} corresponds to a reliability metric calculated for the first received symbol. Thus, two new reliability metric values are calculated using the reliability metric for transmitted symbol 1 at level 1, and two new reliability metric values are calculated using the reliability metric for transmitted symbol −1 at level 1. As a result, four reliability metric values are obtained. Based on these reliability metrics, three best candidates for transmitted symbol sequence are selected for further processing by selecting the symbol sequences represented by reliability metric values having the three lowest values. In our example, symbol sequence {1, −1} (symbol 1 transmitted using the first spreading code channel and symbol −1 transmitted using the second spreading code channel) is discarded at this level as being the least likely candidate.

Then, the process moves to level 3, where reliability metrics are calculated for possibly transmitted symbol sequences {1, 1, 1}, {1, 1, −1}, {−1, 1, 1}, {−1, 1, −1}, {−1, −1, 1} and {−1, −1, −1}, and the three best candidates, {1, 1, −1}, {−1, 1, 1}, {−1, 1, −1}, are again selected and the rest are discarded. The same procedure is carried out at level 4, but now, instead of choosing three best candidates, the best candidate sequence may be directly selected as the most likely transmitted symbol sequence, since level 4 is the last level of the sequence detection process. In our example, the selected sequence is {1, 1, −1, 1}. This means that most likely, symbol 1 has been transmitted using the first spreading code channel, symbol 1 using the second spreading code channel, symbol −1 using the third spreading code channel, and symbol 1 using the fourth spreading code channel. Alternatively, instead selecting the best candidate sequence at the last level, a number of most probable candidates may also be selected at this level, and a decision about the most probable transmitted symbols may be made later, while processing the received signals in the radio receiver.

The reliability metric of the detected symbol sequence, i.e. the sequence selected at the last level as the most probable transmitted symbol sequence, may be used for calculating the reliability of the detection process. This “soft output information” on the detection process may be calculated with respect to one bit by subtracting the reliability metric of the most probable symbol sequence from the reliability metric of the closest symbol sequence having a transmitted data symbol value different than that of the most probable symbol sequence. If no symbol sequence having the latter property exists among the final level reliability metrics, a reliability metric of a symbol sequence with the largest reliability metric or a suitably large constant value may be selected as a soft output information value.

In the above example, the number of the most probable candidates selected for further processing is fixed, but the number of the most probable candidates may also vary. The number of selected candidates may be based on the values of reliability metrics. For example, if it is determined that the value or values of a number of reliability metrics is/are considerably lower, i.e. considerably more probable, than the value(s) of other reliability metrics, the symbol sequence(s) corresponding to this/these reliability metric(s) with lower value(s) may be selected for further processing. On the other hand, if there is a number of reliability metrics having the lowest values with values close to each other, all of the symbol sequences represented by these reliability metrics may be selected for further processing.

The number of candidates to be selected may be determined on the basis of available computational capacity. The computation of the abovementioned symbol detection algorithm may be carried out in a real-time environment, and computational capacity may be limited due to implementational reasons, such as the cost and size of a receiver. In order to reduce computational complexity of the sequence detection algorithm described above, the number of candidates may be chosen such that the algorithm may be computed in real-time. On the other hand, if enough computational capacity is available, the number of candidates may be chosen to be higher in order to improve performance. Thus, the symbol sequence detection algorithm allows for trade-off between computational complexity and performance.

Next, a symbol detection method, when a received signal has been transmitted using space-time block coding, according to an embodiment of the invention will be described. Generally, space-time block coding is a technique used for transmitting symbols with multiple antennas. The transmission of space-time block coded data is based on a space-time block code matrix which, in the case of two transmit antennas, may be as:

$${G}_{2} = [ \begin{matrix}{s}_{1} & {s}_{2} \\ {s}_{2}^{*} & - {s}_{1}^{*}\end{matrix} ] \qquad ( 9 )$$

where s₁ and s₂ are transmitted symbols. A space-time block coded transmission according to matrix G₂ means that during the first time interval, symbol s₁ is transmitted from the first transmitter antenna and symbol s₂ is transmitted simultaneously from the second transmitter antenna. During the second time interval, the symbols −s₂* and s₁* are transmitted simultaneously from the first and the second transmitter antenna, respectively. This enables transmit diversity and, particularly, space-time transmit diversity to be achieved.

When the space-time block coding according to matrix G₂ is used in data transmission, cross-correlation matrix H of equation (4) takes the following form:

$${H}^{′} = ( {\sum }_{i = 1}^{{N}_{p}} [ \begin{matrix}{α}_{i , 1} X ( {d}_{i} - {d}_{1} ) & {α}_{i , 2} X ( {d}_{i} - {d}_{1} ) \\ {α}_{i , 1} X ( {d}_{i} - {d}_{2} ) & {α}_{i , 2} X ( {d}_{i} - {d}_{2} ) \\ ⋮ & ⋮ \\ {α}_{i , 1} X ( {d}_{i} - {d}_{p} ) & {α}_{i , 2} X ( {d}_{i} - {d}_{p} ) \\ {α}_{i , 2}^{*} X ( {d}_{i} - {d}_{1} ) & - {α}_{i , 1}^{*} {X ( {d}_{i} - {d}_{1} )}^{*} \\ {α}_{i , 2}^{*} X ( {d}_{i} - {d}_{2} ) & - {α}_{i , 1}^{*} {X ( {d}_{i} - {d}_{2} )}^{*} \\ ⋮ & ⋮ \\ {α}_{i , 2}^{*} X ( {d}_{i} - {d}_{p} ) & - {α}_{i , 1}^{*} {X ( {d}_{i} - {d}_{p} )}^{*}\end{matrix} ] ) {P}_{2} \qquad ( 10 )$$

where P₂ is a permutation matrix which permutes columns of H′ such that elements corresponding to symbol s₁ (transmitted symbols s₁ and −s₁*) are arranged into the first column and elements corresponding to symbol s₂ (transmitted symbols s₂ and s₂*) are arranged into the second column. Thus, P₂ may be expressed as:

$${P}_{2} = [ \begin{matrix}{I}_{{N}_{c}} ⊗ [ \begin{matrix}1 & 0\end{matrix} ] \\ {I}_{{N}_{c}} ⊗ [ \begin{matrix}0 & 1\end{matrix} ]\end{matrix} ] \qquad ( 11 )$$

where l_{Nc} corresponds to an identity matrix of size N_{c}. Symbol detection of space-time block coded data may be carried out by processing the symbols related to the spreading code channels and the space-time block decoding jointly. The detection may be performed on one space-time code block at a time.

The most probable candidates after the calculation of reliability metrics may be determined as described in the example above with reference to FIG. 3. The calculation of a reliability metric is slightly different from equation (8), and the reliability metric may be calculated according to the following equation:

$${M}_{L + 1}^{′} = {\underbrace{{\sum }_{k = 1}^{{Λ}_{L}} {\vert {y}_{k} - {\sum }_{l = 1}^{L} {h}_{k , l}^{′} {x}_{l} \vert}^{2}}}_{= {M}_{L}^{′}} + {\sum }_{k = {Λ}_{L} + 1}^{{Λ}_{L} + {δ}_{L}^{′}} {\vert {y}_{k} - {\sum }_{l = 1}^{L} {h}_{k , l}^{′} {x}_{l} \vert}^{2} + {\sum }_{k = 1}^{{Λ}_{L} + {δ}_{L}^{′}} {\vert {h}_{k , L + 1}^{′} {x}_{L + 1} \vert}^{2} - 2 ℜ [ {\sum }_{k = 1}^{{Λ}_{L} + {δ}_{L}^{′}} {( {y}_{k} - {\sum }_{l = 1}^{L} {h}_{k , l}^{′} {x}_{l} )}^{*} {h}_{k , L + 1}^{′} {x}_{L + 1} ] \qquad ( 12 )$$

The only difference between equations (8) and (12) is symbol δ_{L} of equation (8) and δ′_{L} of equation (12). While in equation (8) δ′_{L} was a constant equal to the number of rake fingers adapted to each symbol, δ′_{L} is, in our example of two transmitter antennas, a constant equal to two times the number of rake fingers if L is even, and zero if L is odd. Generally, if K transmit antennas are used, δ′_{L} is K times the number of rake fingers, when L is K, 2K etc. This is due to the fact that the receiver has to wait until matrix H′ has been filled up before it can be processed. In our example of two transmit antennas, since one symbol is transmitted two times at different time instants and using different antennas, the receiver has to wait for the reception of both copies of the symbol before it can be processed. At the same time, another symbol is transmitted at the same time instants but using different transmit antennas of the transmitter.

When calculating a reliability metric according to equation (12), now that δ′_{L} is two times the number rake fingers, both copies of the received symbol are used for calculating the reliability metrics for the possibly transmitted symbols. For example, when calculating reliability metrics for transmitted symbol s₁ of equation (9), both received copies s₁ and −s₁* are used for calculating reliability metrics. Thus, more information is available about the transmitted symbol. Naturally, this results in more reliable sequence detection in the receiver. Otherwise, the process is similar to the detection process described above with reference to FIG. 3.

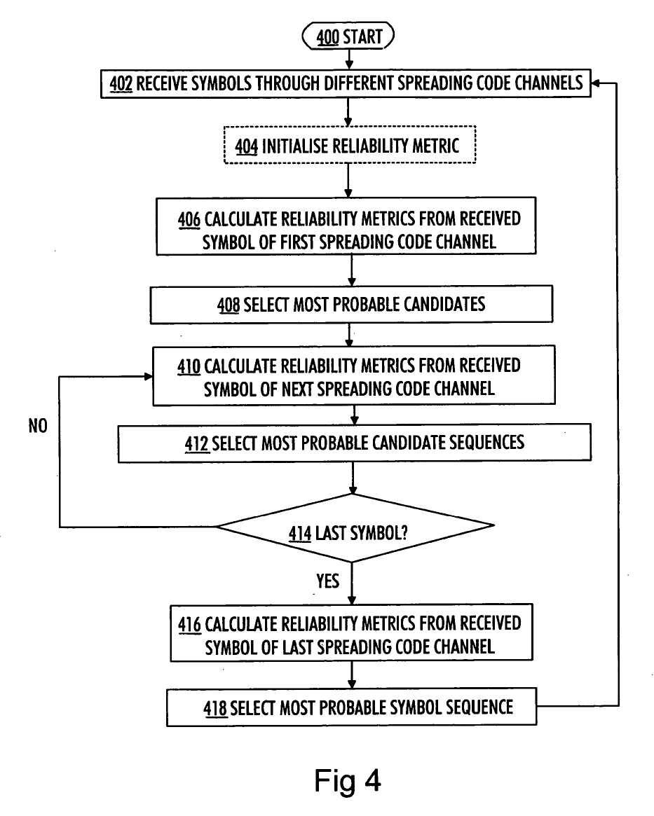

Next, a symbol detection process in a radio receiver utilizing a rake reception mechanism according to an embodiment of the invention will be described with reference to the flow diagram of FIG. 4. The process starts in step 400.

In step 402, a signal comprising a plurality of symbols is received through a plurality of spreading code channels. Each symbol has been modulated with a different spreading code. A receiver utilizes a rake reception mechanism, and rake receiver fingers have been adapted for each received symbol. Prior to a detection process, the received signal is despread using each spreading code.

Next, step 404 is processed. Step 404 is optional, and it is carried out if a reliability metric is determined to be initialised with a determined value. By default, the reliability metric may be initialised with 0.

In step 406, reliability metrics for each possibly transmitted symbol are calculated from the received symbol of a first spreading code channel. The reliability metric for a possibly transmitted symbol may be calculated by calculating a difference, for example a Euclidean distance, between the possibly transmitted symbol and each rake receiver finger adapted for the received symbol, and summing these differences. The possibly transmitted symbol with the lowest summed difference with the received symbol is the most probable transmitted symbol. A number of the most probable candidates is selected in step 408.

Next, reliability metrics are calculated from the received symbol of the next spreading code channel by taking into account reliability metrics calculated for the most probable candidates of the received symbol of the spreading code channel preceding the symbol of the currently processed spreading code channel and by comparing each possibly transmitted symbol with each rake receiver finger adapted for the received symbol at a time in step 410. The adapted rake receiver fingers may differ from the rake receiver fingers adapted for the symbol of the previously processed spreading code channel. A number of the most probable candidates is selected in step 412.

In step 414, it is checked whether the next symbol to be processed is associated with the last spreading code channel. If the next received symbol is not associated with the last spreading code channel, i.e. there are more spreading code channels with a symbol to be processed, the process returns to step 410, where reliability metrics are calculated and, based on the reliability metrics, a number of the most probable candidate sequences is selected in step 412. If the next received symbol is associated with the last spreading code channel, the process moves to step 416, where reliability metrics are calculated from the symbol of the last spreading code channel by taking into account reliability metrics calculated for the most probable candidates preceding the currently processed symbol and by comparing each possibly transmitted symbol with each rake receiver finger adapted for the received symbol at a time in step 410. Then, the most probable transmitted symbol for each spreading code channel is selected in step 418. Alternatively, if a decision about the transmitted symbols is carried out later, a number of the most probable symbols for each spreading code channel may be selected. The selection is based on the reliability metrics calculated in step 416. After step 418 has been executed, the process returns to step 402 and the next symbol for each spreading code channel is received.

The radio receiver of the type described above may be used for implementing the method, but also other types of radio receivers may be suitable for the implementation. In an embodiment, a computer program product encodes a computer program of instructions for executing a computer process of the above-described method of symbol detection in a radio receiver. The computer program product may be implemented on a computer program distribution medium. The computer program distribution medium includes all manners known in the art for distributing software, such as a computer readable medium, a program storage medium, a record medium, a computer readable memory, a computer readable software distribution package, a computer readable signal, a computer readable telecommunication signal, and a computer readable compressed software package.

Even though the invention has been described above with reference to an example according to the accompanying drawings, it is clear that the invention is not restricted thereto but it can be modified in several ways within the scope of the appended claims.

1. A symbol detection method in a radio receiver utilizing a rake receiver, the method comprising:
receiving a signal comprising a plurality of symbols, wherein at least one symbol is modulated with a different spreading code;
adapting rake receiver fingers to properties of radio channels related to a symbol of at least one spreading code;
despreading the signal with at least one spreading code sequence in order to form despread symbols;
calculating, from a despread symbol of a first spreading code, a reliability metric for at least one possibly transmitted symbol by comparing the at least one possibly transmitted symbol with at least one rake receiver finger related to the at least one symbol at a time;
selecting, based on the reliability metric, a number of most probable candidates for the at least one possibly transmitted symbol for further processing;
calculating recursively reliability metrics from a despread symbol of the at least one spreading code by taking into account reliability metrics calculated for most probable candidates preceding the at least one symbol currently being processed and by comparing the at least one possibly transmitted symbol with the at least one rake receiver finger related to the at least one symbol at a time, the reliability metric comprising more information on cross-correlation properties between spreading codes after every calculation of the reliability metric, and
selecting, after calculating the reliability metrics for the at least one possibly transmitted symbol, the number of most probable candidates for a transmitted symbol sequence based on the reliability metrics.

2. The method of claim 1, further comprising selecting, after calculating the reliability metrics for the at least one possibly transmitted symbol from the despread symbol of the last spreading code, most probable symbols for the at least one spreading code based on the reliability metrics.

3. The method of claim 1, further comprising calculating the reliability metrics by calculating a difference between the at least one possibly transmitted symbol and the at least one symbol.

4. The method of claim 1, further comprising initialising the reliability metric with a determined value before calculating a first reliability metric of a first symbol of a symbol sequence.

5. The method of claim 1, further comprising selecting the most probable candidates by selecting symbols having lowest reliability metrics.

6. The method of claim 1, further comprising:
calculating soft output information on a chosen symbol sequence; and
calculating forward error correction by utilizing the soft output information.

7. The method of claim 1, further comprising selecting a fixed number of the most probable candidates.

8. The method of claim 1, further comprising selecting the number of the most probable candidates based on a known criterion.

9. The method of claim 8, further comprising selecting the number of the most probable candidates based on values of the reliability metrics.

10. The method of claim 1, further comprising:
receiving the signal transmitted using space-time block coding; and
detecting space-time block code jointly with symbol detection.

11. A radio receiver utilizing a rake receiver, the radio receiver comprising:
a communication interface for receiving a signal comprising a plurality of symbols, wherein at least one symbol is modulated with a different spreading code sequence; and
a control unit configured to adapt rake receiver fingers to properties of a radio channel related to a symbol of at least one spreading code;
despread the signal with at least one spreading code sequence in order to form despread symbols;
calculate, from a despread symbol of a first spreading code, a reliability metric for at least one possibly transmitted symbol by comparing the at least one possibly transmitted symbol with at least one rake receiver finger related to the at least one symbol at a time;
select, based on reliability metrics, a number of most probable candidates for the at least one possibly transmitted symbol for further processing;
calculate recursively reliability metrics from a despread symbol of the at least one spreading code by taking into account reliability metrics calculated for the most probable candidates preceding the at least one symbol currently being processed and by comparing the at least one possibly transmitted symbol with the at least one rake receiver finger related to the at least one symbol at a time, the reliability metric comprising more information on cross-correlation properties between spreading codes after every calculation of the reliability metric, and
select, after calculating the reliability metrics for the at least one possibly transmitted symbol, the number of most probable candidates for a transmitted symbol sequence based on the reliability metrics.

12. The radio receiver of claim 11, wherein the control unit is further configured to select, after calculating the reliability metrics for the at least one possibly transmitted symbol from a last received symbol of the spreading code, a most probable symbol sequence based on the reliability metrics.

13. The radio receiver of claim 11, wherein the control unit is further configured to calculate the reliability metrics by calculating a difference between the at least one possibly transmitted symbol and the at least one symbol.

14. The radio receiver of claim 11, wherein the control unit is further configured to initialise the reliability metric with a determined value before calculating a first reliability metric of a first symbol of a symbol sequence.

15. The radio receiver of claim 11, wherein the control unit is further configured to select the most probable candidates by selecting symbols or symbol sequences having lowest reliability metrics.

16. The radio receiver of claim 11, wherein the control unit is further configured to calculate soft output information on a chosen symbol sequence and calculate forward error correction by utilizing the soft output information.

17. The radio receiver of claim 11, wherein the control unit is further configured to select a fixed number of the most probable candidates.

18. The radio receiver of claim 11, wherein the control unit is further configured to select the number of the most probable candidates based on a known criterion.

19. The radio receiver of claim 18, wherein the control unit is further configured to select the number of the most probable candidates based on values of the reliability metrics.

20. The radio receiver of claim 11, wherein the control unit is further configured to:
receive a signal transmitted using space-time block coding through the communication interface, and
detect space-time block code jointly with sequence detection.

21. A radio receiver utilizing a rake reception mechanism, the radio receiver comprising:
communication means for receiving a signal comprising a plurality of symbols, wherein at least one symbol is modulated with a different spreading code sequence;
adapting means for adapting rake receiver fingers to properties of a radio channel related to a symbol of at least one spreading code;
dispreading means for despreading the signal with at least one spreading code sequence in order to form despread symbols;
first calculating means for calculating, from a despread symbol of a first spreading code, a reliability metric for at least one possibly transmitted symbol by comparing the at least one possibly transmitted symbol with at least one rake receiver finger related to the at least one symbol at a time;
first selecting means for selecting, based on reliability metrics, a number of most probable candidates for the at least one possibly transmitted symbol for further processing;
second calculating means for calculating recursively reliability metrics from a despread symbol of the at least one spreading code by taking into account reliability metrics calculated for the most probable candidates preceding the at least one symbol currently being processed and by comparing the at least one possibly transmitted symbol with the at least one rake receiver finger related to the at least one symbol at a time, the reliability metric comprising more information on cross-correlation properties between spreading codes after every calculation of the reliability metric, and
second selecting means for selecting, after calculating the reliability metrics for the at least one possibly transmitted symbol, the number of most probable candidates for a transmitted symbol sequence based on the reliability metrics.

22. A computer program embodied on a computer-readable medium, the computer program including instructions for controlling a computer process of symbol detection in a radio receiver utilizing a rake receiver to perform the steps of:
receiving a signal comprising a plurality of symbols, wherein at least one symbol is modulated with a different spreading code sequence;
adapting rake receiver fingers to properties of a radio channel related to a symbol of at least one spreading code;
despreading the signal with at least one spreading code sequence in order to form despread symbols;
calculating, from a despread symbol of a first spreading code, a reliability metric for at least one possibly transmitted symbol by comparing the at least one possibly transmitted symbol with at least one rake receiver finger related to the at least one symbol at a time;
selecting, based on reliability metrics, a number of most probable candidates for the at least one possibly transmitted symbol for further processing;
calculating recursively reliability metrics from a despread symbol of the at least one spreading code by taking into account the reliability metrics calculated for the most probable candidates preceding the at least one symbol currently being processed and by comparing at least one possibly transmitted symbol with the at least one rake receiver finger related to the received at least one symbol at a time, the reliability metric comprising more information on cross-correlation properties between the at least one spreading code after every calculation of the reliability metric, and
selecting, after calculating the reliability metrics for the at least one possibly transmitted symbol, the number of most probable candidates for a transmitted symbol sequence based on the reliability metrics.

23. A computer program distribution medium readable by a computer and encoding a computer program of instructions for executing a computer process of symbol detection in a radio receiver utilizing a rake receiver, the process comprising:
receiving a signal comprising a plurality of symbols, wherein at least one symbol is modulated with a different spreading code sequence;
adapting rake receiver fingers to properties of a radio channel related to a symbol of at least one spreading code;
despreading the signal with at least one spreading code sequence in order to form despread symbols;
calculating, from a despread symbol of a first spreading code, a reliability metric for at least one possibly transmitted symbol by comparing the at least one possibly transmitted symbol with at least one rake receiver finger related to the at least one symbol at a time;
selecting, based on reliability metrics, a number of most probable candidates for the at least one possibly transmitted symbol for further processing;
calculating recursively reliability metrics from a despread symbol of the at least one spreading code by taking into account the reliability metrics calculated for the most probable candidates preceding the at least one symbol currently being processed and by comparing the at least one possibly transmitted symbol with the at least one rake receiver finger related to the at least one symbol at a time, the reliability metric comprising more information on cross-correlation properties between the at least one spreading code after every calculation of the reliability metric, and
selecting, after calculating the reliability metrics for the at least one possibly transmitted symbol, the number of most probable candidates for a transmitted symbol sequence based on the reliability metrics.

24. The computer program distribution medium of claim 23, the distribution medium comprising at least one of the following mediums:
a computer readable medium, a program storage medium, a record medium, a computer readable memory, a computer readable software distribution package, a computer readable signal, a computer readable telecommunications signal, and a computer readable compressed software package.
